(19) United States
(12) Patent Application Publication
(10) Pub. No.: US 2022/0138572 A1
(43) Pub. Date: May 5, 2022

(54) Systems and Methods for the Automatic Classification of Documents

(71) Applicants: Dezhao SONG, Eagan, MN (US); Andrew VOLD, Rosemount, MN (US); Kanika MADAN, Toronto (CA); Frank SCHILDER, St. Paul, MN (US)

(72) Inventors: Dezhao SONG, Eagan, MN (US); Andrew VOLD, Rosemount, MN (US); Kanika MADAN, Toronto (CA); Frank SCHILDER, St. Paul, MN (US)

(73) Assignee: Thomson Reuters Enterprise Centre GmbH, Zug (CH)

(21) Appl. No.: 17/515,818

(22) Filed: Nov. 1, 2021

Related U.S. Application Data
(60) Provisional application No. 63/107,839, filed on Oct. 30, 2020.

(51) Int. Cl. G06N 3/08; G06F 9/48

(52) U.S. Cl. CPC G06N 3/08; G06F 9/4881

(57) ABSTRACT

Systems and computer implemented methods for classifying documents are provided that include: pretraining and then fine tuning a machine learning model with a domain specific dataset that includes a plurality of documents each annotated with at one label selected from a plurality of predefined labels for a given domain; and predicting using the trained/fine tuned machine learning model, at least one label from the plurality of labels for at least one other document. The machine learning model is preferably fine tuned using a label attention multi-task learning process that includes: a first task for training the machine learning model with respect to all labels used for the plurality of documents in the dataset, and a second task for training the machine learning model with respect to a subset of all of the labels used for the plurality of documents in the dataset.

### RELATED APPLICATION

This application claims the benefit of U.S. Provisional Patent Application No. 63/107,839, filed on Oct. 30, 2020, which is hereby incorporated herein by reference.

### COPYRIGHT NOTICE

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

The present application relates to methods and systems for automatic document classification, and more particularly for the automated classification of documents using machine learning methodologies and related uses of such classified documents.

Research platforms that provide curated resources are known. Westlaw®, for example, provides access to legal documents, such as case opinions, expertly classified with respect to various classification schemes, including for example with respect to the procedural posture of the case to which a given legal document pertains. Processes for classifying documents, especially legal opinions, can be labor intensive. Additionally, doing so reliably requires highly skilled and experienced editors, which are nonetheless prone to error.

Accordingly, there is a need for improved methods and systems to reliably classify documents or textual portions thereof that are not as labor intensive, may not require such skilled editors, and/or provide more reliable output.

### SUMMARY

In one aspect, a computer implemented method for classifying documents is provided that includes: training, by a computer device, a machine learning model with a domain specific dataset comprising a plurality of documents each annotated with at least one label selected from a plurality of predefined labels for a given domain; and predicting, by the computer device, using the trained machine learning model, at least one label from the plurality of labels for at least one other document. Preferably, the machine learning model is trained using a multi-task learning process that includes: a first task for training the machine learning model with respect to all of the labels used for the plurality of documents in the dataset, and a second task for training the machine learning model with respect to a subset of all of the labels used for the plurality of documents in the dataset.

In one embodiment, the dataset includes a plurality of legal documents, the plurality of labels comprises a plurality of procedural postures, and the at least one annotated document is labeled with at least one procedural posture.

In one embodiment, the dataset includes a plurality of documents labeled with at least one of a first set of procedural postures in no more than 0.1% of the documents in the dataset and wherein the machine learning model is trained to label the at least one other document with the first set of procedural postures.

In one embodiment, the dataset includes a document labeled with a first procedural posture in only one of the documents in the dataset and wherein the machine learning model is trained to label at least one other document with the first procedural posture.

In one embodiment, the machine learning model is a neural language model.

In one embodiment, the machine learning model is a machine learning model pretrained with general-domain corpora and the computer implemented process comprises continued training of the general-domain corpora pretrained machine learning model with the domain specific dataset.

In one embodiment, the plurality of documents in the dataset are labeled following a Zipfian distribution.

In one embodiment, the subset of labels includes only small classes determined based on how many documents in the plurality of documents in the dataset are tagged a given label.

In one embodiment, the first task for training the machine learning model includes: representing each of the labels for the first task as a vector, computing a cosine distance between the labels for the first task and an output from the machine learning model, determining a weight matrix for the first task based on the computed cosine distances, classifying a sample of the output from the machine learning model therewith providing a dense output for the first task, and multiplying the dense output for the first task with the weight matrix for the first task therewith providing a final classification output.

In one embodiment, the second task for training the machine learning model includes: representing each of the labels for the second task as a vector, computing a cosine distance between the labels for the second task and an output from the machine learning model, determining a weight matrix for the second task based on the computed cosine distances, classifying a sample of the output from the machine learning model therewith providing a dense output for the second task, wherein labels for the second task include only small classes determined based on how many documents in the plurality of documents in the dataset are tagged a given label, and multiplying the dense output for the second task with the weight matrix for the second task therewith providing a small classification output.

In one embodiment, the method includes pretraining the machine learning model using a portion of at least one document in the dataset.

In one embodiment, the method includes pretraining the machine learning model using at least one document with noisy text filtered therefrom.

In one embodiment, the method includes pretraining the machine learning model using documents processed with N-Gram topic modeling.

In one embodiment, the method includes pretraining the machine learning model after applying sentence reranking.

In one embodiment, the process includes pretraining the machine learning model using masked language modeling.

In one embodiment, the masked language modeling comprises randomly selecting tokens from the original document and replacing a portion of the selected tokens with a mask token, and wherein the machine learning model predicts token values based on tokens surrounding the mask token.

Additional aspects of the present invention will be apparent in view of the description which follows.

### BRIEF DESCRIPTION OF THE FIGURES

FIG. 1 is a table showing ground truth analysis of one embodiment of the POSTURE50K dataset.

FIG. 2 is a table showing word count analysis of one embodiment of the POSTURE50K dataset.

FIG. 3 is a block diagram of one embodiment of a system for training a machine learning model.

FIG. 4 is a block diagram of one embodiment of an architecture for the system for pretraining a machine learning model.

FIG. 5 is a block diagram of one embodiment of an architecture for an embedding layer for the system for pretraining a machine learning model.

FIG. 6 is a block diagram of one embodiment of an architecture for a language model head layer for the system for pretraining a machine learning model.

FIGS. 7A-7B, 8, and 9A-9B are figures and tables evaluating the machine learning model trained in accordance with the disclosure herein.

FIG. 10 is a table showing an exemplary list of procedural postures.

FIG. 11 is an interface screen showing an implementation of the documents classified with procedural postures in accordance with the present disclosure.

FIG. 12 is a block diagram of a system for the automatic classification of textual content according to at least one embodiment of the systems disclosed herein.

FIG. 13 is a block diagram of a method for the automatic classification of textual content according to at least one embodiment of the methods disclosed herein.

### DETAILED DESCRIPTION

Documents frequently need to be classified for various purposes, whether for organization, search/retrieve functions, or for the generation of derivative materials, such as legal text annotations. As discussed herein, document classification, particularly with respect to legal documents, is labor intensive and the reliability of the classification is often dependent on the skill and experience of the editor. The present application provides computer implemented methods and systems for the automated classification of documents, preferably multi-label classification of documents, which improve classification reliability and/or reduce the amount of skilled labor required for classification using known methodologies.

Multi-label document classification has broad applicability, such as for sentiment analysis, medical code classification, social media, etc. A variety of methods have been developed for such problems, including traditional one-vs-all classifiers, classical machine learning approaches (e.g., Random Forest and Multi-layer Perceptron) and deep neural networks. These algorithms continue to improve state-of-the-art performance on datasets from different domains.

In the legal domain, there exists a strong demand for state-of-the-art multi-label classification algorithms for different tasks, such as legal motion detection and case outcome prediction. However, researchers and practitioners are often faced with two major challenges. On one hand, there exists only a few human annotated legal textual datasets, and the lack of high-quality manually labeled data has become a major obstacle in further advancing state-of-the-art research in this field. On the other hand, while existing methods have been continuing to achieve a higher performance in the respective tasks, they primarily focus on the majority classes and struggle to achieve decent performance for classes that do not have sufficient training samples. This could be especially problematic for tasks in the legal domain. For example, for legal motion detection, compared to major motion categories (e.g., Motion to Dismiss), less frequent types (e.g., Motion for Permanent Injunction) also play an important role in the litigation process. Missing low-frequency but important motions may result in impactful consequences for parties involved in a lawsuit, for example. Accordingly, there is a need for improved methods and systems for reliably classifying such low-frequency documents.

Accordingly, in one aspect, a curated dataset is provided, generally referred to as the “POSTURE50K” dataset, which contains 50K legal cases that were annotated by legal subject matter experts with a selection of the most important/significant Legal Procedural Postures, ranging from frequent types of procedural postures (e.g., On Appeal) to less frequent or rare types of procedural postures, where, for example, only one occurrence appears in the entire dataset. Procedural postures generally include motions on which a judge has ruled and have subsequently been challenged in a higher court. In addition, the motions preferably also need to be substantively discussed by the judge of the higher court. An inter-annotator agreement study of the ten most frequent procedural poster labels in the dataset showed a high Cohen's Kappa score of 0.81 averaged over these ten labels. Many of the low-frequency labels also show high agreement.

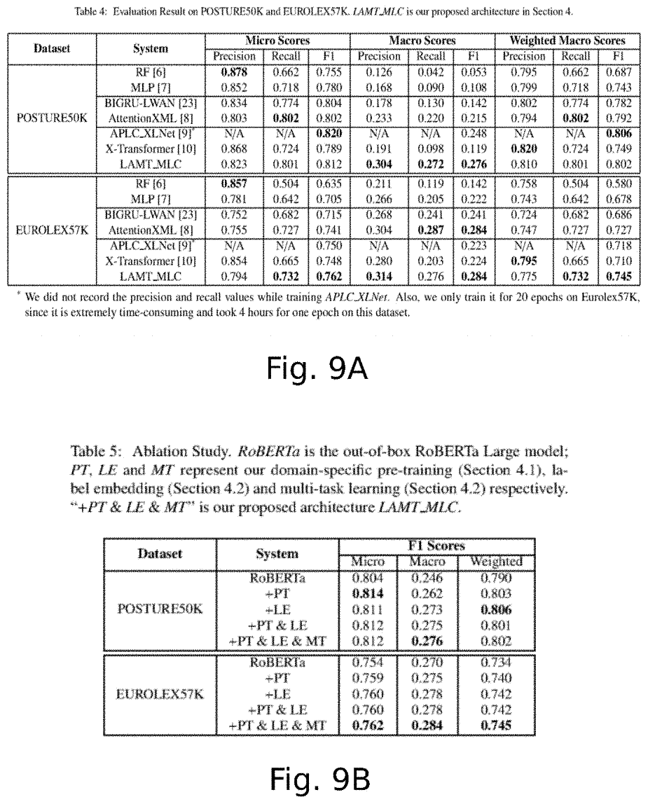

The labels in this dataset also followed a Zipfian distribution with many of them having just a few samples, e.g., 50 or less instances in a 50 k dataset. This is common in real-world scenarios, which often prevents supervised methods from producing satisfying results, as indicated by the low Macro-F1 scores (<0.28) of all evaluated systems in Table 4 (FIG. 9A). It is believed that this challenging classification task goes beyond topic classification and may also require legal reasoning, such as identifying the parties involved and encoding the knowledge of motions and other procedures of a lawsuit. Also, due to the long tail nature of the labels, some labels only occur in the test set, making this dataset especially attractive for few-shot or zero-shot learning techniques.

As a second aspect, a deep learning-based system is provided that is built on top of a machine learning model, preferably the RoBERTa model in the legal domain, for multi-label legal document classification. Instead of simply using the out-of-the-box (OOB) RoBERTa model, continued pre-training was performed on the given dataset to facilitate the downstream multi-label classification task. To address the issue of not having sufficient training samples for the low-frequency classes, a label-attention mechanism may be adopted that helps to bridge the semantic gap between a given legal document and the classes (i.e., the procedural postures). To further strengthen the signals of the low-frequency classes, multi-task learning may be used where a second task specifically focuses on those classes. Testing shows that the proposed system outperforms two baseline and another four recent state-of-the-art deep learning methods on both POSTURE50K and EUROLEX57, another legal multi-label dataset covering diverse topics, e.g., privacy, finance, etc.

### MULTI-LABEL CLASSIFICATION MODELS

Traditional machine learning methods have been adopted for multi-label classification problems, such as one-vs-all classifiers, tree-based approaches, and Multilayer Perceptron. In terms of features, early approaches normally utilize TF-IDF (Term Frequency-Inverse Document Frequency) vectors while recent systems have mostly adopted embedding-based features.

In the past few years, deep learning-based approaches have been developed for multi-label classification problems as well. The organizers of the Chinese AI and Law (CAIL) challenge, for example, applied Convolutional Neural Networks (CNN) to two legal classification tasks and achieved higher accuracy than a SVM baseline that uses TF-IDF features. In Label-Wise Attention Network (LWAN), the word embeddings of each document are first converted to a sequence of vectors by a CNN or bi-directional GRU encoder. It then uses independent attention heads (one for each label) to generate document embeddings from the sequence of vectors produced by the encoder. Each document embedding then goes through a separate dense layer with a sigmoid activation in order to produce the probability of the corresponding label. On a task to predict medical codes for clinical notes, it achieved better Micro-F1 scores than simple CNN and bi-directional GRU networks over 8,922 labels from the MIMIC-III dataset. AttentionXML builds shallow and wide probabilistic trees with a multi-label attention mechanism where the same text is represented differently for each label. Instead of using a single tree, it uses ensembles to integrate results from three separate trees.

Language models have seen substantial advancements over the past several years, such as Embeddings from Language Models (ELMo), Generative Pre-Training (GPT), BERT, RoBERTa, XLNet and their variations. They are pre-trained on a large corpora of general-domain texts, trying to capture dependencies and contextual information over much longer pieces of text rather than just only over a few adjacent words. In general, distributed representations over words not only help in better learning the local dependencies, but can also capture more meaningful semantic relationships.

More recently, language models have been extensively studied for multi-label classification problems, where a pre-trained language model is further fine-tuned for a domain-specific task. APLC_XLNet fine-tunes the pre-trained XLNet model and explores clustering a large amount of labels in order to improve training efficiency. X-Transformer adopts a similar idea of label clustering in order to reduce the label space; furthermore, it utilizes a ranker as an additional step to rank the model output and uses an ensemble mechanism to integrate results from multiple models in order to produce the final outputs. Instead of fine-tuning out-of-the-box language models, domain-specific pre-training has shown to improve performance on corresponding downstream tasks.

Multi-label classification models built on language models may benefit from improvements disclosed herein.

### Multi-label Datasets

Several multi-label/multi-class datasets already exist, such as the Reuters Corpus Volume I (RCV1), the Amazon review data, Wikipedia Tags, MIMIC-III, EURLEX57K, ECHR and CAIL2018. These datasets cover a variety of domains, including news, medicine, on-line platforms (e.g., Wikipedia and Amazon), and legal. In terms of size, they vary substantially, ranging from 20K tagged Wikipedia articles to millions of online product reviews and legal cases.

The datasets most similar to POSTURE50K are ECHR and CAIL2018. The European Court of Human Rights (ECHR) hears allegations that a state has breached human rights provisions of the European Convention of Human Rights. The task is to predict whether any human right protocol has been violated (binary classification) and if so, which protocols (multi-label classification). It contains 11.5K cases from ECHR's public databases. Compared to ECHR, the POSTURE50K dataset is much larger with 50K legal cases and covers diverse legal areas. CAIL2018 contains 2.6 million cases from China's Supreme Court and includes three tasks: finding the law articles that were violated, determining the charges (e.g., intentional injury) and prison term (e.g., six months of prison time). Although this dataset is at a much larger scale than ours, it only contains criminal cases while our dataset covers different legal areas, such as civil, criminal, bankruptcy, etc. Furthermore, in CAIL2018, for the tasks of predicting violated law articles and determining charges, there are 183 and 202 different categories respectively while the POSTURE50K dataset has 256 different types of procedural postures.

Finally, in the POSTURE50K dataset, the labels follow a Zipfian distribution in terms of their count, and many posture categories occur in 50 cases or less (below). Few-shot and zero-shot learning may be some of the promising candidate techniques to addressing the task we are proposing with this dataset.

### The POSTURE50K Dataset

The POSTURE50K dataset includes 50K legal opinions from the United States (covering all 50 states and the District of Columbia), most of which are between the year of 2013 and 2020 (with 3 cases prior to 2013). The cases cover diverse legal areas, such as civil, criminal, bankruptcy, etc., and are from different U.S. courts, including Supreme Court, Court of Appeals, Trial Court, and so on. The section that follows describes how the dataset was created, how consistency of the annotated labels was ensured, and provides an analysis of the labels and the textual contents. Although this dataset has been assembled to address classification in the legal domain, it is understood that the processes disclosed herein apply to datasets in other domains having similar characteristics, including with respect to the label count distribution and occurrence (e.g., less than 50 instances).

### The POSTURE50K Dataset—Background

As noted above, procedural postures preferably include motions that a judge has previously ruled on and are subsequently challenged in a higher court. In addition, they should also be substantively discussed by the judge of the higher court. Procedural postures range from very common motions (e.g., Motion to Dismiss) to rare types (e.g., Motion to Admonish Jury, etc.). Determining the postures may seem to be easy to identify by simply matching keywords in a legal case. For example, Case 1 below has a procedural posture of Motion to Dismiss for Lack of Personal Jurisdiction as clearly indicated by the bolded text in the text of the opinion for Case 1 below. The entire context, however, is important and only if the motion is sufficiently discussed by the judge is a procedural posture label warranted.

Case 1: “In this personal injury action, the plaintiff has alleged that the defendants, [Name-I], [Name-2] and [Name-3], caused a motor vehicle accident Sep. 1, 1991, in which the plaintiff sustained “severe, painful, disabling, disfiguring, and permanent injuries.” Defendant [Name-2] has moved pursuant to Fed.R.Civ.R 12(b)(2) to dismiss the complaint against him on the basis that this court lacks in personal jurisdiction. The plaintiff has filed his brief in opposition, to which the defendant has replied. The time for further reply has passed and the motion is ripe for disposition. For reasons which follow, the court will grant defendant [Name-2]'s motion to dismiss.”

Although it may be possible to detect certain postures by using simple keyword-based features plus a sufficient discussion of the motion, it would be much more difficult to determine the postures for other cases where deep understanding of legal texts and/or inferences are required. The text of Case 2 below shows two paragraphs from the opinion text of another case. The first paragraph contains a Motion to Dismiss for Lack of Personal Jurisdiction as part of the bolded text; it is, however, not being discussed in further detail throughout the rest of the opinion. Instead, as written in the second paragraph, the judge argues that the motion should have been challenged by extraordinary writ and not by appeal. Note, for determining the procedural posture, it does not matter whether the cited rulings are overwritten by a later court decision, as this was the case for the citations in this judgment. Therefore, the Motion to Dismiss for Lack of Personal Jurisdiction label should not be identified as a procedural posture for this case.

Case 2: “The claim against [Name-I] was based on vicarious liability arising out of his alleged status as [Name-2]'s employer [Name-1] moved to dismiss for lack of personal jurisdiction on Oct. 24, 1985, filing a supporting affidavit stating that he was a co-employee with [Name-2] at [Name-3].

Dismissal for lack of personal jurisdiction is not a final judgment from which an appeal will lie. Schwenker v. St. Louis County National Bank, 682 S. VI/.2d 868, 870 (Mo. App.I984). The right of an appeal is statutory, and an appeal may be taken only from a final judgment. In this connection, a dismissal for lack of personal jurisdiction is by the terms of the statute § 510.150, RSMo I986 and Rule 67.03, without prejudice unless the order of dismissal finally adjudicates the claim. Id. An order dismissing a suit for lack of personal jurisdiction is properly challenged by extraordinary writ but not by appeal.”

In the second example, it is evident that there may be legal proceedings and reasoning discussed in the opinions that would require a more sophisticated approach to detecting procedural postures beyond the use of simple keywords. Our experiments (discussed below) show that a Random Forest (RF) classifier using n-grams achieved a Micro-F1 score of 0.755 but a Macro-F1 score of only 0.053. This indicates that many postures can indeed be identified by specific keywords while actual understanding of legal procedures and reasoning in the case texts would be required in order to achieve better coverage for the broad range of classes (i.e., higher Macro-F1 scores).

### The POSTURE50K Dataset—Expert Annotation

Editors were used to manually tag cases with procedural postures. All editors had professional legal background and were further trained to perform this specific tagging task. Each case may be tagged with one or more postures, thus making this a multi-label dataset. In total, the preferred dataset includes 256 different procedural posture categories. The labels may be hierarchical (e.g., Motion to Dismiss and its sub-categories), and the editors were instructed to tag with the most specific type. On average, each case was tagged with 1.54 postures, with the maximum and minimum being 9 and 0, respectively.

During tagging, each case was worked on by a single editor to conserve resources. To further examine the reliability of the ground truth, an additional inter-annotator study was performed. Based upon the tagged procedural postures, 200 cases that contain the ten most frequent posture categories and another 200 cases that contain the 80 least frequent posture categories were randomly selected. Four legal professionals were invited to tag the two groups of 200 cases independently, i.e., two of them were asked to tag the first group of 200 cases with the top ten posture categories and the other two annotators were asked to tag the other 200 cases with the 80 least frequent posture categories. This way, the inter-annotator study examines both the popular and the rare posture categories.

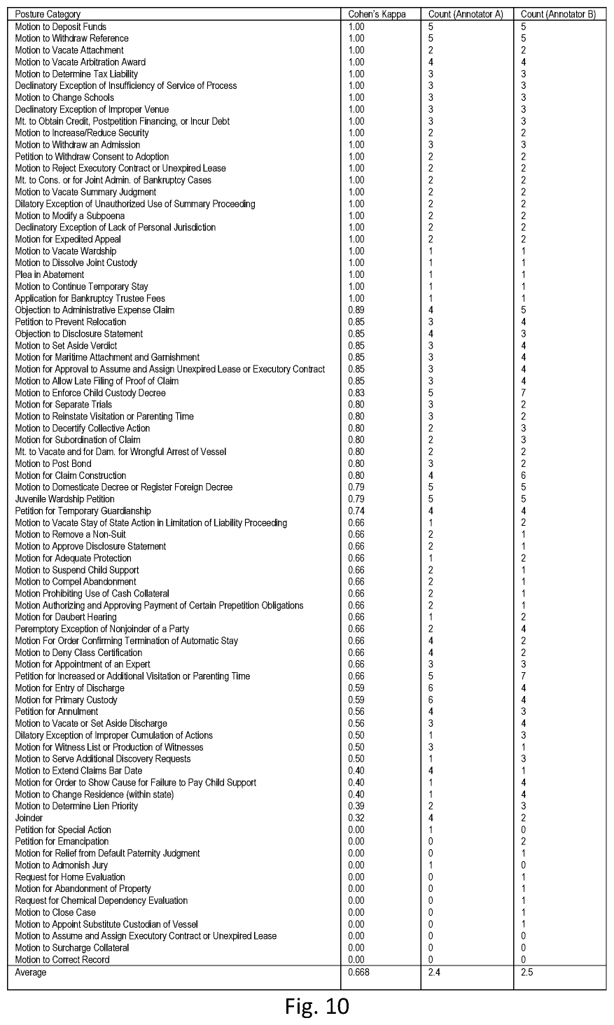

Table 1 below shows the Cohen's Kappa scores for the ten most frequent postures. A and B represent the two annotators. All ten postures have a Kappa score greater than 0.61, suggesting substantial to almost perfect agreement between the two annotators. For the 80 least frequent postures, the Kappa scores are shown in FIG. 10. In this set, 56 have a Kappa score higher than 0.61, suggesting substantial to almost perfect agreement while another seven posture categories have a Kappa score between 0.41 and 0.60, indicating moderate agreement. Note, the original Kappa scores for Motion to Dismiss and Post-Trial Hearing Motion were 0.49 and 0.33 respectively. After further training, the annotators re-adjudicated the cases, which improved the scores to 0.79 and 0.77 respectively. For example, Motion to Dismiss is difficult to tag, given there are several sub-categories. The guideline is to only use the general Motion to Dismiss tag when the sub-categories do not exist in a case. This initially caused confusions to the annotators.

TABLE 1
Cohen's Kappa Scores for the Top Ten Most Frequent Posture
Categories (A and B represent the two annotators).

| | Cohen's | Count | Count |
|---|---|---|---|
| Posture Category | Kappa | (A) | (B) |
| Appellate Review | 0.92 | 71 | 66 |
| Motion for Attorney's Fees | 0.86 | 14 | 16 |
| Sentencing or Penalty Phase | 0.84 | 43 | 44 |
| Motion or Objection | | | |
| On Appeal | 0.83 | 98 | 111 |
| Review of Administrative Decision | 0.82 | 52 | 50 |
| Lack of Subject Matter Jurisdiction | 0.81 | 12 | 10 |
| Motion for Preliminary Injunction | 0.80 | 4 | 6 |
| Motion to Dismiss | 0.79 | 32 | 22 |
| Post-Trial Hearing Motion | 0.77 | 12 | 11 |
| Trial or Guilt Phase | 0.63 | 16 | 29 |
| Motion or Objection | | | |
| Average | 0.81 | 35 | 37 |

### Dataset Splits

In order to make this dataset suitable for supervised learning tasks, it was split into Train, Development (Dev), and Test sets. Table 2 shows the high-level statistics of the resulting POSTURE50K dataset, where the Posture Category represents the total number of different posture types in each split. Posture, Paragraph and Word represent the number of individual posture tags, the number of paragraphs and the number of words per legal case, respectively. Instead of performing a simple random split, certain rules in the process were adopted to make this dataset more challenging and also suitable for different tasks. The dataset may be split as follows:

Step 1: At the very beginning, all the cases were randomly divided into three splits, aiming for the ratios of 0.64 (Train), 0.16 (Dev), and 0.20 (Test).

Step 2: In this dataset, several posture categories only occur in a single legal case. Therefore, all cases that are tagged with such posture categories were moved to Test, making this dataset a good candidate for evaluating zero-shot learning techniques.

Step 3: Furthermore, because certain posture categories were only tagged a handful of times (i.e., they occur in two or just a few cases), the random split may put all cases with such postures into Train, which makes those posture categories useless. Therefore, a check was performed as to whether any posture category occurs in Train only, Dev only, Train and Dev only, or Dev and Test only. If so, for each of such posture categories, its cases were evenly re-distributed into the three splits by prioritizing Test over Train and Train over Dev. For example, when a posture category only occurs in two cases, one was put in Test and another one in Train.

Step 4: In Step 3, it is possible that a case occurs in more than one of the splits. For instance, when re-distributing two different posture categories one after another, a case that was tagged with both postures may be re-distributed twice into different splits. Thus, as a last step, the disjointedness of the three splits was checked and cases that occur in more than one split were removed from less important splits (importance: Test>Train>Dev). For example, when a case exists in both Train and Test, it was removed from Train.

Through the above split process, the posture categories in Dev are a subset of those in Train and Test; at the same time, Train's posture categories are all covered in Test.

TABLE 2
POSTURE50K Statistics.

| | | | \|Posture\| | \|Paragraph\| | \|Word\| |
|---|---|---|---|---|---|
| Dataset | | \|Posture | (Avg/ | (Avg/ | (Avg/ |
| Split | [symbol] | Category\| | Max/Min) | Max) | Max) |
| Train | [symbol] | 232 | 1.54/9/0 | 30/1, | 2,892/124, |
| Develop- | | 182 | | 174 | 134 |
| ment | | 256 | 1.54/6/0 | 30/502 | 2,851/47, |
| Test | | | | | 017 |
| | | | 1.55/6/0 | 31/1, | 2,970/179, |
| | | | | 828 | 861 |
| Total | [symbol] | 256 | 1.54/9/0 | 30/1, | 2,901/179, |
| | | | | 828 | 861 |

[symbol]

indicates data missing or illegible when filed

### Dataset Analysis

The dataset may be released as three json files, representing Train, Dev, and Test, respectively. In the files, each line is the json representation of a single legal case. Each case preferably has three fields: documentld (a unique identifier for the case), postures (a list of manually tagged procedural postures for this case), and sections (the different sections in a legal case opinion from the courts). Each section further consists of a headtext (the title of a section) and paragraphs (a list of textual paragraphs in the section) while not all sections have a headtext. Here, the sections may be Facts, Analysis, Discussion, etc.

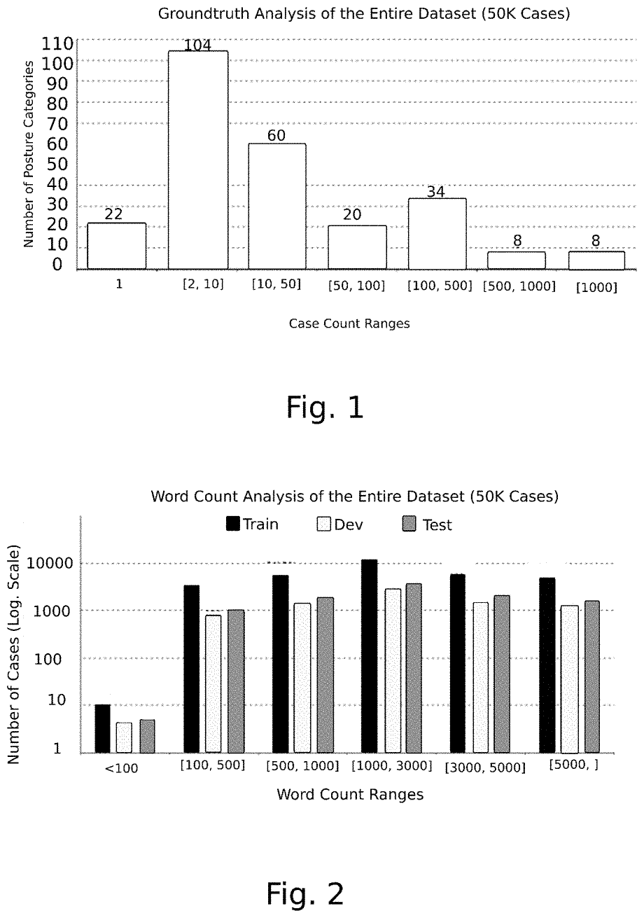

Groundtruth Analysis. FIG. 1 depicts an analysis on the tagged procedural postures. Among the 256 posture categories, only eight of them (the very right bar) occur in more than 1,000 cases with another eight posture categories occurring between 500 and 1000 cases. Furthermore, a total of 186 categories (the sum of the three bars from left) appear in less than 50 cases, among which 22 categories only exist in a single case. All these characteristics make the dataset an ideal candidate for researching and evaluating few-shot and zero-shot learning techniques.

Content Analysis. In addition to its multi-label and few-shot/zero-shot nature, there were also a few additional challenges. First, adopting existing off-the-shelf NLP tools to process the data may be challenging, e.g., PoS tagging, sentence splitting, etc. Many of the available tools were only built with/for standard English texts (e.g., news); thus, they may not work well for processing legal texts. Furthermore, many of the case documents in this dataset are (extremely) long. In Table 2, we see that the average number of paragraphs is 30 and the average number of words is 2,901. As further demonstrated in FIG. 2, the majority of the cases have more than 500 words. For the Training set (Train), counting the two bars from right, there are 11,156 cases with more than 3,000 words, accounting for 35% of the Train split. Therefore, this dataset presents significant challenges for some of the state-of-the-art techniques (e.g., BERT and other Transformer based approaches) due to their difficulties in handling long texts. As discussed in more detail below, the system provided herewith improves classification coverage, especially on low-frequency classes.

### Label-attended Multi-label Classification with Domain-specific Pre-training

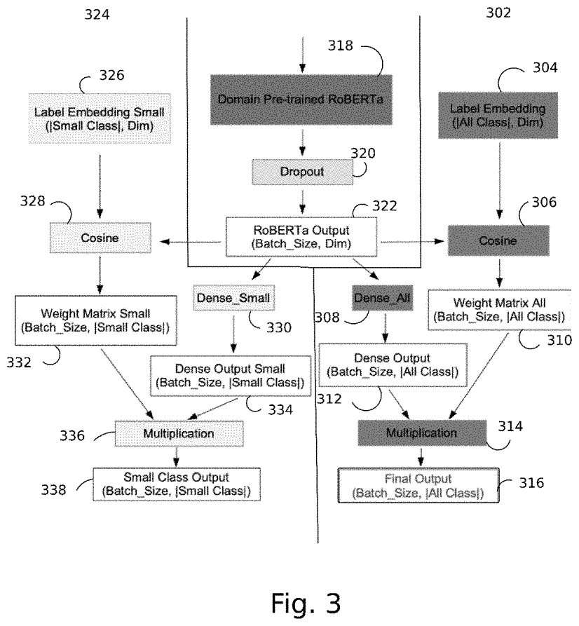

According to one embodiment, the present application provides a deep learning-based approach for multi-label classification. Generally speaking, this approach consists of one or more of three major components as demonstrated in FIGS. 3-6: Domain-specific Pre-training, Label-attention, and Multi-task learning.

### Domain-Specific Language Model Pre-Training

Out-of-the-box (OOB) language models (such as BERT and RoBERTa) were designed for language understanding before applying to downstream tasks, such as question answering, text classification, etc. The task of fitting these models to the English language, known as pre-training, involves predicting the values of unseen tokens over one or more large-scale and also general-domain language corpora. By learning the nuances of the language ahead of time, transformer-based models are able to generate features from the language, rather than having to learn them only from the specific downstream tasks.

Although learning the language from domain agnostic corpora has led to state-of-the-art performances on various NLP tasks, when applied to a specific downstream task in a given domain, the model often needs to learn to adjust itself (i.e., the pre-trained model weights) to this domain. This is especially challenging for small to mid-scale datasets or classes that do not have sufficient amounts of training samples. To address this issue, continued domain-specific pre-training was performed on top of an OOB RoBERTa Large model on each of the two datasets noted above (POSTURE50K and EUROLEX57K), which showed that the further pre-trained domain-specific models achieve better performances than OOB RoBERTa models, as discussed below.

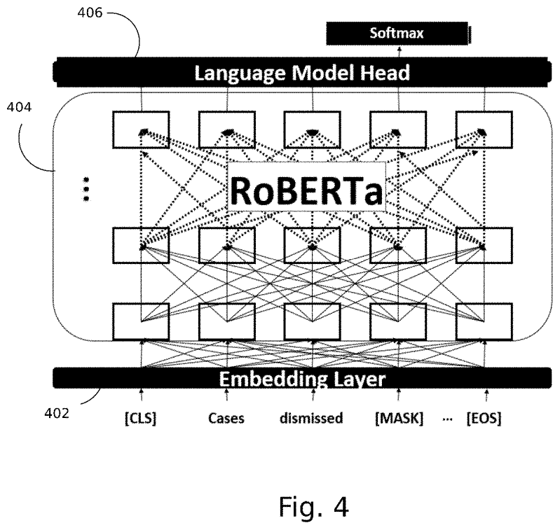

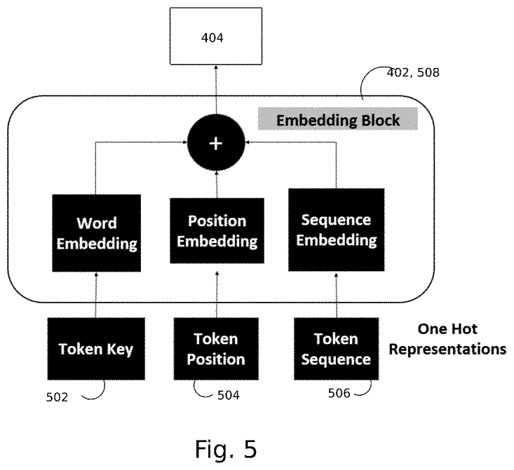

As shown in FIG. 4, the system using the RoBERTa architecture consists of an embedding layer 402, the RoBERTa transformer 404, and a language model head 406 blocks. More specifically, the embedding layer 402, as shown in FIG. 5, preferably consists of three different embedding types to create a dense representation of a token's meaning, position, and sequence membership. The token key embedding layer 502 maps a one-hot representation of a token to a dense representation. The position embedding layer 504 maps a token's absolute position to a dense representation, so the transformer architecture can learn the spatial correlation of the words within a passage of text. The token sequence embedding layer 506 maps a token's sequence membership to a feature vector, which has utility when the input passage consists of several spans of text. Some examples include masking words in a pair of sentences, sentence pair classification, etc. The output of each of these layers is elementwise summed by the embedding block 402, 508 and fed into the transformer block 404 for continued pretraining of the RoBERTa model.

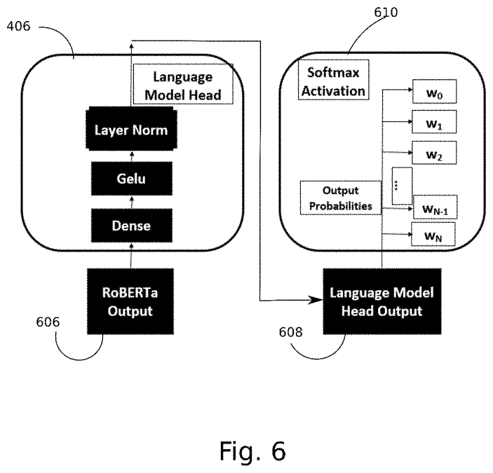

Next, as further shown in FIG. 6, the output of the embedding layer 402 is fed into the RoBERTa transformer block 404, which consists of stacked self-attention layers, preferably 24 layers for RoBERTa large. The output 606 of the transformer block 404 is fed into the language model head 406, which has the objective of mapping the transformer feature space to feature space of the training task at hand. In the case of masked language modeling, this consists of mapping the feature space of the transformer block to a dense representation (Language Model Head Output 608) to be used as inputs to a softmax activation 610 that converts this input and outputs a vector or vectors of probabilities.

Although RoBERTa's architecture is essentially the same as that of BERT, it uses dynamic masking and was pre-trained with more data and additional training steps. Moreover, RoBERTa's pre-training does not involve the next sentence prediction task; instead, the categorical cross entropy loss is minimized for masked tokens as shown in FIG. 4 and Equation 1:

$$J ( θ ) = - \frac{1}{N} {\sum }_{i = 1}^{N} {y}_{i} log ( {p}_{i} ) , \qquad Equation 1$$

where pᵢ is the softmax probability of label i.

RoBERTa language model domain-specific pre-training may be the exact same task as what was performed in its original pretraining on general-domain corpora, except that a randomly initialized softmax classifier is attached to the transformer architecture, and that the training corpus is a domain-specific dataset. For our continued pre-training, we use the RoBERTa Large model from Huggingface and randomly select 15% of the tokens. Among the selected tokens, 80% of them are replaced with a special [MASK] token, 10% are unchanged, and the last 10% are replaced with a different token from the vocabulary. It is then up to the model to use the surrounding tokens to predict the token values of the masked tokens. We perform this domain-specific pre-training for a fixed number of epochs, save the model after each epoch, and empirically choose the best model by using the development set of the data.

### Label-attended Multi-task Learning

As shown in FIG. 1, 186 classes in the POSTURE50K dataset have 50 or fewer cases, which presents a significant challenge for statistical machine learning systems to produce decent models. To address this issue, a label-attended multi-task learning is provided where the embeddings of the class labels (e.g., the embeddings of Motion to Dismiss, On Appeal, etc.) is utilized to bridge the semantic gap between samples and the classes.

In FIG. 3, the right side rectangles 302 represent the components of the label-attention mechanism and the texts in parentheses indicate the shape of the corresponding matrices. To start, Label Embedding block 304 represents each class label as a vector (of dimension Dim). Then, the cosine distances between such label embeddings and the output of the domain-specific RoBERTa model were computed (block 306), and the distances were used as a weight matrix (Weight Matrix All 310). The intuition behind this weight matrix is that it is used to measure how similar the RoBERTa output is to the class labels in high-dimensional space in order for the learning process to better capture the low-frequency classes. In the meantime, the output of the domain-specific RoBERTa model 322 is also sent to a dense layer (Dense_All 308) in order to classify a sample to the label space (Dense Output 312). Finally, instead of using this dense output as the final results, it was multiplied with the weight matrix 314 (i.e., Weight Matrix All, the cosine distance matrix) in order to produce the final classification output 316. Essentially, the label embedding and the cosine weight matrix work as an attention to the model output, better projecting it to the label space.

There are different ways to initialize the label embeddings. The simplest approach is to adopt randomized initialization, which may not work well given the complexity of the RoBERTa architecture. Another option is to use the average of the embeddings of the words in the labels; however, with this option, we lose the connections between the words in the labels by treating them (mostly) as independent. Instead, the label embeddings may be initialized by using Sentence Transformers, a sentence embedding model fine-tuned on top of the out-of-the-box RoBERTa Large model. By treating class labels as “sentences”, their sentence embeddings were produced and they were used as the initial weights of Label Embedding 304. During training, the label embeddings were made trainable, so that they continue to be adjusted for the given dataset and the specific classification task.

In order to further strengthen the signals of the low-frequency classes, the processes for multi-task learning noted above were used to classify only the small classes (determined by how many training samples a class has in the dataset). The architecture of this task (the left side rectangles 324 in FIG. 3) is the same as the primary task (all class embedding) with two differences. First, the label embedding 326 for this secondary task only consists of those of the small classes. Also, the dense layer 330 (Dense_Small) projects the RoBERTa output 322 only to the label space of the small classes 334. In our system, the multiplied output (Final Output 316 in FIG. 3) is used as the final results while another alternative is to use ensemble on the outputs of the two tasks (e.g., by averaging the outputs of the small classes from both tasks); however, we found that it did not help during our evaluation.

### Evaluation

In the section that follows, the evaluation metrics, comparison systems, hardware and other experimental setup are introduced and the results of applying the proposed deep learning architecture to the two datasets are discussed.

### Evaluation Setup

Datasets. The system was evaluated on two datasets: POSTURE50K and EUROLEX57K. EUROLEX57K is another legal multi-label dataset that covers a variety of topics, such as environment, finance, transportation, etc. It contains three splits: Train, Dev and Test with 45K, 6K and 6K documents respectively. The task was to classify each document to a pre-defined set of topics where each document may be assigned more than one topic, i.e., multi-label classification. In total, there were 4,271 different classes. EUROLEX57K is a newer and larger version of the well-adopted EUROLEX dataset.

Metrics. State-of-the-art systems often utilize the Precision at k (P@k) scores as the evaluation metrics; however, later in this section, we show that these metrics may not truly reflect the capabilities of multi-label classification systems. The Micro-F1 score, the Macro-F1 score, and the Weighted Macro-F1 score (including their corresponding precision and recall) were adopted as the main evaluation metrics. In addition, the training times for different types of models were also examined, shedding some light on the trade-offs between performance gains and (time and monetary) cost.

Comparison Systems. First, Random Forest (RF) and Multi-layer Perceptron (MLP) were used as two baselines where simple n-gram features were used. Furthermore, the system was compared to two attention-based state-of-the-art neural networks that do not use pre-trained language models: BIGRU-LWAN and AttentionXML. Finally, the proposed deep learning architecture Label-attended Multi-task Multi-label Classification (LAMT_MLC) was evaluated against another two state-of-the-art systems that are also based on pre-trained language models: APLC_XLNet and X-Transformer. For APLC_XLNet, the original implementation uses XLNet Base while the proposed system uses RoBERTa Large; thus, it was changed to use XLNet Large in order to perform a fair comparison. For the X-Transformer, its RoBERTa Large option was used.

Parameter Tuning. The tuned parameters are shown in Table 3 for RF and MLP. For MLP, it was trained for 50 and 100 iterations on POSTURE50K and EUROLEX57K, respectively and its performance scores were obtained. For both systems, the optimal number of n-gram features ranging from 1K to 6K were tuned. For BIGRU-LWAN, its major parameters were experimented with: number of layers (1 to 3), size of hidden states (300, 600 and 900), learning rate (1e-3, 1e-4, 1e-5, 2e-5, 3e-5 and 5e-5), dropout rate (0.1 to 0.4), and batch size (8, 16 and 32). For AttentionXML, the important parameters were tuned, including size of hidden states (64, 128, 256, 512 and 1,024), number of layers (1 and 2), and dropout rate (0.4, 0.5, 0.6 and 0.7).

TABLE 3
Parameters for Random Forest (RF) and Multilayer Perceptron (MLP)

| Parameter | RF | MLP |
|---|---|---|
| Number of Trees | 30, 50, 60 | N/A |
| Tree Depth | 10, 20, 30, 50 | N/A |
| Feature Percentage for | 0.1, 0.2, 0.3, | N/A |
| Each Tree | 0.4 | |
| Number of Layers | N/A | 1, 2, 3 |
| Number of Hidden States | N/A | 25, 50, 100, 150, |
| | | 200, 300 |
| Learning Rate | N/A | 1e-2, 1e-3, 1e-4 |
| Batch Size | N/A | 32, 64, 128, 256, 512 |

| | |
|---|---|
| Total Feature Size | 1K, 2K, 3K, 4K, 5K, 6K |
| N (-gram) | 1, 2, 3, 4, 5 |

For APLC_XLNet, the focus was on tuning the three learning rates that it uses for different modules (XLNet layers, the sequence summary layer and the final dense layer), and we only used a batch size of 3 which is the largest that could fit to the memory of the GPU. As for the X-Transformer system, a batch size of 4 was used, and different learning rates (1e-5, 2e-5 and 5e-5) and embedding types (TF-IDF and Text Embedding) were experimented with. X-Transformer also supports ensembles which require training models by using different architecture and embedding combinations, such as RoBERTa-TFIDF, XLNet-Text-Embedding and so on. It then performs the ensemble on the predictions from such models. Since training these models would be extremely time and resource-intensive, its ensemble option was not used. In terms of the proposed system LAMT_MLC, the Adam optimizer was adopted with a learning rate of le-5 and a batch size of 4. In addition, for both X-Transformer and our system, mixed precision training was performed in order to speed up the process. When tuning the baselines and the state-of-the-art systems, instead of trying out the exhaustive combinations of all possible parameter values, the systems were tuned by changing one parameter at a time.

Domain-specific Pre-training and Multi-task Learning. For the proposed system LAMT_MLC, the out-of-the- box RoBERTa Large model was pre-trained on the Train split of the corresponding datasets for one epoch. Longer pre-training was also experimented with, which did not provide further performance improvements. When pre-training, sentences with less than five words were removed. For multi-task learning, we include all classes with fewer than 10 samples into the secondary task.

Model Selection. For all deep learning systems, the Macro-F1 score was used on the Development set to select the best model and compute the scores on the Test set. As will be shown, the systems achieve similar Micro-F1 and Weighted-F1 scores, thus these two metrics may not truly reflect how well each system performs, especially on low-frequency classes. On both datasets, the systems were trained for 30 epochs with an early stopping of 10 epochs on their Macro-F1 scores.

Hardware. For RF and MLP, all experiments were conducted on an AWS EC2 m5.24×large instance: 96 vCPUs and 384 GB of RAM. For RF, since experimentation involved up to 60 trees, the entire training was parallelized. For deep learning-based approaches, all models were trained on an AWS EC2 p3.2×large instance that has a single V100 GPU.

### Results

Baselines. Table 4 (FIG. 9A) shows the results of all systems on the Test set of both datasets. Comparing the two traditional machine learning methods, it can be seen that MLP clearly shows a better performance than RF across nearly all metrics (except for Weighted precision on EUROLEX57K and Micro precision on both datasets). Compared to RF's training time of 25 and 216 minutes on POSTURE50K and EUROLEX57K, respectively, it took MLP only 4 and 105 minutes to train the models, thus making it a potentially better choice than RF on both datasets. It is not surprising that the two baselines have substantially lower F1 scores than the other approaches on both datasets.

Attention-based Methods. Compared to BIGRU-LWAN that also uses label-attention, the proposed system LAMT_MLC achieved substantially better F1 scores on both datasets. In terms of AttentionXML, the proposed system has clear advantages on all three F1 scores on POSTURE50K; although AttentionXML achieved the same Macro-F1 score as our system on the EUROLEX57K dataset, its Micro and Weighted-F1 scores are substantially lower than that of our system.

Language Model-based Systems. Finally, for the three language model-based approaches, on EUROLEX57K, the proposed LAMT_MLC achieved the highest scores on most of the metrics (except for Micro and Weighted precision). In particular, its substantially higher Macro-F1 scores demonstrate the advantages of using label-attention and domain-specific pretraining in covering the small classes. On POSTURE50K, although APLC_XLNet has slightly higher Micro and Weighted-F1 scores than our system, its Macro-F1 is only about 25%, nearly 3% lower than that of our system. Moreover, comparing the training time, it took APLC_XLNet about 3 and 4 hours to train one epoch on POSTURE50K and EUROLEX57 respectively while the proposed system LAMT_MLC only needed about 45 and 60 minutes on the two datasets, respectively. Therefore, it is believed that the system disclosed herein has a clear advantage over APLC_XLNet both performance and cost-wise.

Ablation Study. In Table 5 (FIG. 9B), an ablation study was performed in order to examine the effectiveness of the different components of the proposed system. First, compared to the OOB RoBERTa Large architecture, adopting either domain-specific pre-training (PT) or the label embedding (LE) alone allowed the system to achieve better performances on all three F1 scores, especially on the POSTURE5OK dataset. Although the combination of PT and LE did not further improve the performance on EUROLEX57K, by adding multi-task learning, our system was able to further achieve slightly better performances. Finally, although the proposed system has very similar Micro and Weighted-F1 scores to the OOB RoBERTa Large model, by adopting domain-specific pre-training and label embedding, it shows clear advantages on Macro-F1 scores, especially on POSTURE50K. This demonstrates the effectiveness of our architecture in covering low-frequency classes.

### Discussion

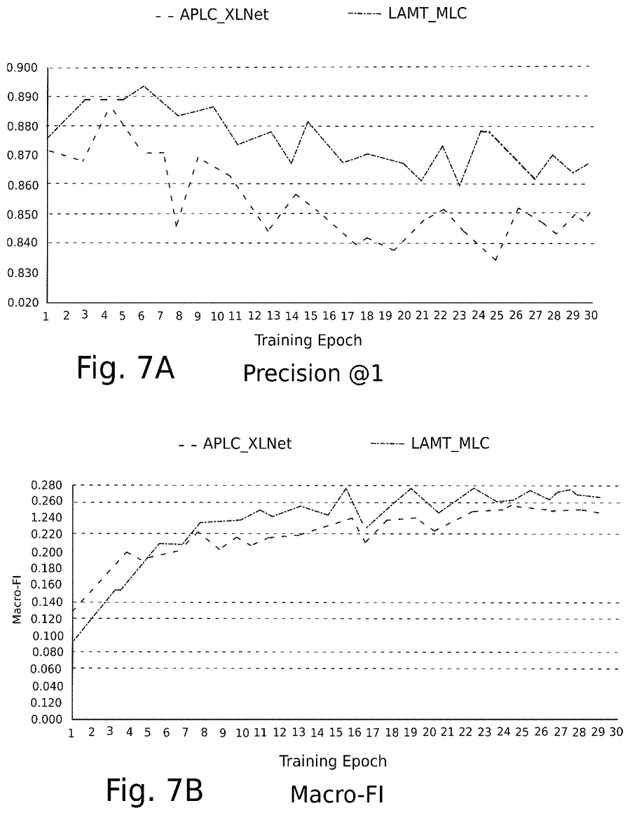

Choosing the Most Appropriate Evaluation Metrics. As mentioned above, state-of-the-art systems often chose to evaluate their multi-label classification approaches using the Precision at k scores (P@k where k normally equals 1, 3 and 5). However, during our evaluation, it was found that P@k may not be the most appropriate metric. FIGS. 7A and 7B show the P@1 and the Macro-F1 scores of APLC_XLNet and the proposed LAMT_MLC on the POSTURE50K dataset for each epoch. It can be seen that both systems achieved their highest P@1 scores with just a few epochs of training; however, for the rest of the training process, the P@1 scores kept dropping. In the meantime, one can see a different trend for the Macro-F1 scores where they continue to improve and become stable after 15 to 20 epochs. Therefore, for systems with the goal of being able to cover a broad range of classes, the P@1 metric may not be the most appropriate option; instead, one may consider using the Macro-F1 score and a longer training process.

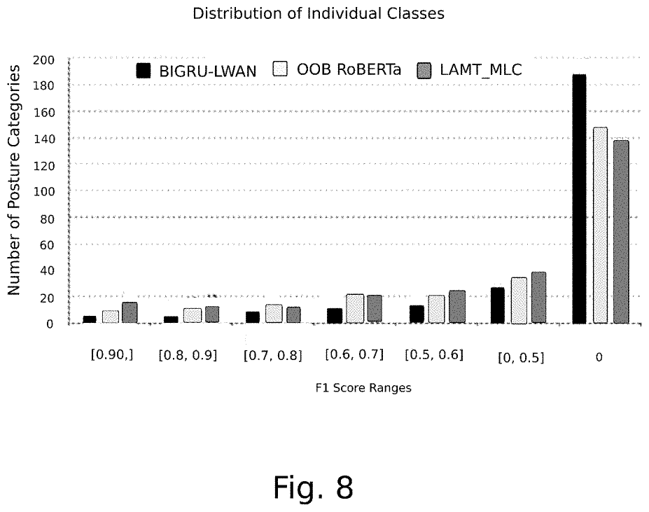

Micro-F1 vs Macro-F1. In Table 5 (FIG. 9B), one observation is that although the proposed system shows clear advantages in its coverage (i.e., higher Macro scores), all variations were able to achieve very similar Micro and Weighted-F1 scores. For example, on POSTURE50K, the proposed system achieved a 3% higher Macro-F1 score than the OOB RoBERTa system while their Micro-F1 and Weighted-F1 scores only differ by about 1%; even more concerning, in Table 4 (FIG. 9A), BIGRU-LWAN's Micro-F1 score is only 0.8% lower than that of the proposed system on the POSTURE50K dataset while with a 13% lower Macro-F1 score. FIG. 8 demonstrates the individual class F1 scores of BIGRU-LWAN, OOB RoBERTa, and LAMT_MLC on POSTURE50K. One can see that even with very similar Micro F1 scores, LAMT_MLC allowed better performances for more classes than the other two systems. For real-world applications, it is important to understand how well a system does on the different classes by choosing the most appropriate metrics.

Monetary and Time Cost Analysis. One goal of research is to keep improving the scores; however, when adopting these techniques in a real-world setting, we unavoidably need to consider the trade-offs between better scores and the (time and monetary) cost to produce those models. For example, on the POSTURE50K dataset, AttentionXML and LAMT_MLC needed about 2 and 30 minutes respectively to train one epoch. In total, the two systems took about 1 and 15 hours respectively for 30 epochs of training. Given that the EC2 instance we are using costs about 4 USD/hour, this translates to a monetary cost of 4 USD for AttentionXML and 60 USD for LAMT_MLC. These additional time and monetary costs gave us about 1% better Micro-F1 score and 6% higher Macro-F1 score. For a real-world application where the goal is to simply focus on the majority classes, AttentionXML is clearly a better choice; however, when trying to be more comprehensive on detecting the small classes, LAMT_MLC would be a better choice. Depending on the application scenarios, one may choose the more appropriate approaches. One interesting research direction is to explore strategies to speed up the training of those complex models, so that one could enjoy their better performance with a more acceptable (time and monetary) cost.

The POSTURE50K dataset presents a real-world and challenging multi-label classification task, i.e., tagging legal cases with procedural postures, a very important concept in the legal domain and for the litigation process. Furthermore, the LAMT_MLC is proposed herein, a deep learning system that is based on the RoBERTa language model for performing multi-label classification. Instead of using the out-of-the-box RoBERTa model, further pre-training was performed using domain-specific datasets. For targeting datasets where there was a lack of sufficient training samples, a label-attention mechanism and multi-task learning were adopted in order to achieve better coverage, especially on small classes. By evaluating on two large-scale datasets, the proposed system substantially outperforms two baseline and another four state-of-the-art systems.

The POSTURE50K dataset is a multi-label classification dataset containing 50K legal documents with their respective Procedural Posture labels. It is demonstrated above that domain transfer via masked language modeling over the individual paragraphs in the training set prior to performing classification finetuning yields substantial improvements. Separating all the documents into component paragraphs yields>O(100K) training examples for pretraining, and thus takes a few hours for a single epoch on a p3.2×large AWS instance. Though this is not considered to be a heavy resource demand, the pretraining could be more efficient by only considering pieces of text which are relevant for predicting their Procedural Postures. Accordingly, in one embodiment the more informative pieces of text within the entire document may be strategically selected considering the statistics of the terms which occur in each sentence within a document. Doing this, the training pool size may be cut down by an order of magnitude, and the text used for pretraining is useful for identifying Procedural Postures. Various techniques may be used to reduce the size of the pretraining document. For example, the documents for pretraining may be processed to remove noisy text, e.g., citation to cases and non-standard English language. Moreover, sentences that contain numbers and not much text may be removed.

In one embodiment, N-Gram Topic Modeling may be used in this regard, where a nested dictionary with N-Gram outer index and topic inner index is created. The dictionary may be filled by counting all the N-Grams which occur in a topic for a particular document. The N-Gram rate may be determined by dividing values by the total number of N-Gram counts for the topic in consideration and take logarithm. Thereafter, a 2D matrix may be created by performing elementwise subtraction of all possible log-likelihood combinations for the N-Gram and all N-Gram matrices may be concatenated to form 3D tensor.

In another embodiment, Sentence Reranking may be used on documents for pre-training. This generally involves breaking documents down into a list of sentences split by regex pattern. Each sentence may be vectorized by recording counts of N-Grams inside the sentence and a tensor dot product applied between sentence vectors and absolute value of N-Gram log-likelihood tensor. The sum over all topic hypotheses may then be determined and a torch tensor filled by a concatenating ordered list of tokenized sentences in descending order up to 512 token limit.

In one embodiment, Masked Language Modeling (MLM) may be used for pretraining in which 15% tokens are sampled from the sequence at random. 80% of time, the sampled tokens are replaced with mask token, 10% of time, replaced with different token in the vocabulary, and 10% of time, nothing is done to the selected token. The original token assignments for the selected tokens are predicted and the weights adjusted by minimizing the cross-entropy loss.

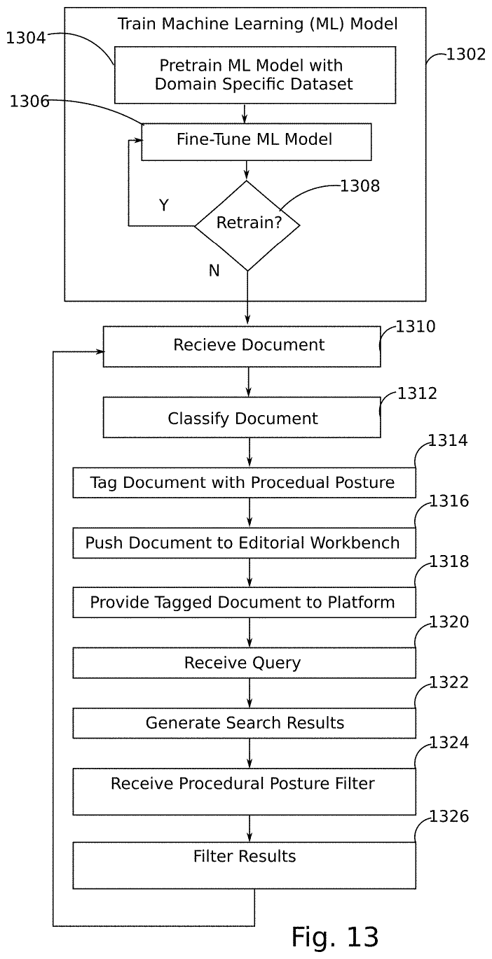

Filtering noisy tokens, N-Gram topic modeling, and sentence re-ranking are generally different ways of selecting text snippets (e.g., sentences) from a document; such selected texts may then be used for pretraining and/or fine tuning (1304, 1306 and 1308 in FIG. 13). In this regard, these processes may be applied to documents prior to pretraining with masked language modeling.

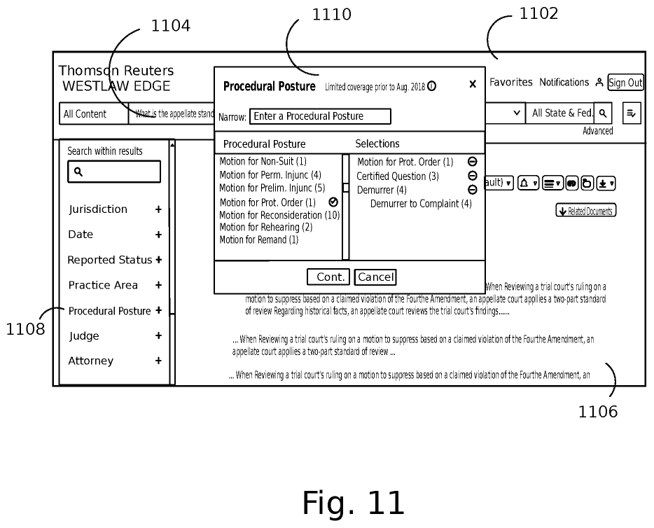

FIG. 11 depicts an implementation for documents classified with procedural posture as discussed herein. As discussed above, Westlaw® provides access to legal documents, such as case opinions, etc. The Westlaw® service provides an interface 1102 with a form element 1104 (text box) for a user to enter terms for a query. In response, Westlaw® displays a panel 1106 with the results of the search based on the query terms. The service may also provide a panel 1108 with form elements, such as a search text box or predefined topics for filtering the search results. Preferably, the filter topics include a procedural posture option, which enables the user to filter results based on the procedural posture classification assigned to documents in accordance with the present disclosure. For example, in response to the selection of this filter, a procedural poster interface screen 1110 may be displayed, which includes therein a list of procedural postures across the search results. A user may then select one or more of the postures on the list for the narrowing of the search results. As discussed above, the model trained in accordance with the present disclosure is better able to classify documents with low frequency procedural postures, thereby improving the results for end users.

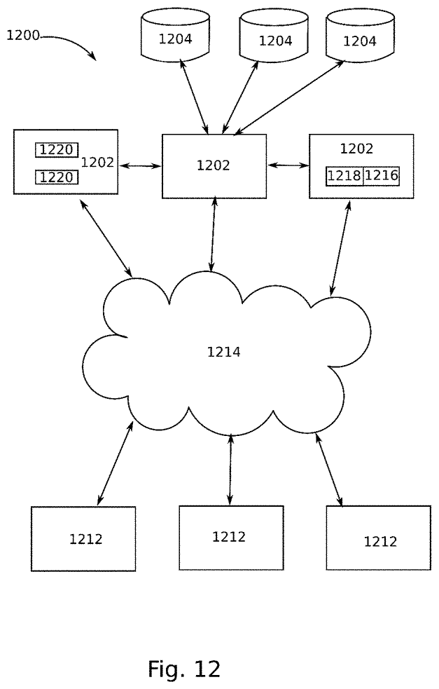

FIG. 12 shows an exemplary system for the automatic classification of textual content. In one embodiment, the system 1200 includes one or more servers 1202, coupled to one or a plurality of databases 1204. The servers 1202 may further be coupled over a communication network to one or more client devices 1212. Moreover, the servers 1202 may be communicatively coupled to each other directly or via the communication network 1214.

The databases 1204 preferably include case law databases and a statutes database, which respectively include judicial opinions and statutes from one or more local, state, federal, and/or international jurisdictions. Additional databases may include legal documents of secondary legal authority, such as an ALR (American Law Reports) database, an AMJUR database, a West Key Number (KNUM) Classification database, and a law review (LREV) database. Metadata databases may include case law and statutory citation relationships, quotation data, headnote assignment data, statute taxonomy data, procedural postures, etc.

The servers 1202 may vary in configuration or capabilities but are preferably special-purpose digital computing devices that include at least one or more central processing units 1216 and computer memory 1218. The server(s) 1202 may also include one or more of mass storage devices, power supplies, wired or wireless network interfaces, input/output interfaces, and operating systems, such as Windows Server, Unix, Linux, or the like. In an example embodiment, server(s) 1202 include or have access to computer memory 1218 storing instructions or applications 1220 for the performance of the various functions and processes disclosed herein, including maintaining one or more classification models, and using such models for predicting procedural postures of a legal case or opinion, as discussed above. The servers may further include one or more search engines and a related interface component, for receiving and processing queries and presenting the results thereof to users accessing the service via client devices 1212. The interface components generate web-based user interfaces, such as a search interface with form elements for receiving queries, a results interface for displaying and filtering the results of the queries, such as the interface shown in FIG. 11, as well as interfaces for editorial staff to manage the information in the databases, over a wireless or wired communications network on one or more client devices.

The computer memory may be any tangible computer readable medium, including random access memory (RAM), a read only memory (ROM), a removable storage unit (e.g., a magnetic or optical disc, flash memory device, or the like), a hard disk, or etc.

The client devices 1212 may include a personal computer, workstation, personal digital assistant, mobile telephone, or any other device capable of providing an effective user interface with a server and/or database. Specifically, client device 1212 includes one or more processors, a memory, a display, a keyboard, a graphical pointer or selector, etc. The client device memory preferably includes a browser application for displaying interfaces generated by the servers 1202.

FIG. 13 depicts a flowchart of one embodiment of a process for the classification of text. The process may generally begin at 1302 with the training of a machine learning model to classify documents. Preferably this involves pretraining 1304 an out-of-the box model, such as the RoBERTa model, with a domain-specific dataset, such as the POSTURE50K, as discussed above. The pretrained model may be fine-tuned at 1306 and retrained 1308 as necessary or as desired to achieve acceptable results, as discussed herein. Once trained, the model may be applied to classify documents. Specifically, the system and/or server may receive a document to be classified at 1310. The system may then classify the document using the trained/fine tuned model at 1312 and the document is tagged or otherwise associated in a database, for example, with one or more classes according to a multi-label classification scheme at 1314. Optionally, the classified document may be pushed to an editorial workbench at 1316 to confirm the classification as well as to perform other editorial tasks. A tagged document may then be provided to the service for use therein at 1318.

Although the systems are discussed herein relative to the legal field, the present disclosure is applicable to other fields as well. Therefore, the platform may provide any service that may benefit from the automated classification of low frequency labels, as discussed herein. For legal research services, the tagged documents may be stored in one or more databases, as discussed above in relation to FIG. 12. The legal service may receive a query at 1320 from a user, which results in the service/servers generating search results at 1322. The search results are communicated to a user client device by the servers and displayed in an interface screen, such as the interface screen shown in FIG. 11. The interface screen may include an element for filtering the search results based on procedural posture, for example. In response to receipt of the procedural posture from the client device, the service/servers may filter the results presented to the user at 1326. The process may be repeated for additional searches and for other users.

While the foregoing invention has been described in some detail for purposes of clarity and understanding, it will be appreciated by one skilled in the art, from a reading of the disclosure, that various changes in form and detail can be made without departing from the true scope of the invention.

What is claimed is:

1. A computer implemented method for classifying documents comprising:
training, by a computer device, a machine learning model with a domain specific dataset comprising a plurality of documents each annotated with at least one label selected from a plurality of predefined labels for a given domain, wherein the machine learning model is trained using a multi-task learning process comprising:
a first task for training the machine learning model with respect to all of the labels used for the plurality of documents in the dataset, and a second task for training the machine learning model with respect to a subset of all of the labels used for the plurality of documents in the dataset; and
predicting, by the computer device, using the trained machine learning model, at least one label from the plurality of labels for at least one other document.

2. The computer implemented method of claim 1, wherein the dataset comprises a plurality of legal documents, the plurality of labels comprises a plurality of procedural postures, and the at least one annotated document is labeled with at least one procedural posture.

3. The computer implemented method of claim 2, wherein the dataset comprises a plurality of documents labeled with at least one of a first set of procedural postures in no more than 0.1% of the documents in the dataset and wherein the machine learning model is trained to label the at least one other document with the first set of procedural postures.

4. The computer implemented method of claim 2, wherein the dataset comprises a document labeled with a first procedural posture in only one of the documents in the dataset and wherein the machine learning model is trained to label at least one other document with the first procedural posture.

5. The computer implemented method of claim 2, wherein the machine learning model is a neural language model.

6. The computer implemented method of claim 1, wherein the machine learning model is a machine learning model pretrained with general-domain corpora and the computer implemented process comprises continued training of the general-domain corpora pretrained machine learning model with the domain specific dataset.

7. The computer implemented method of claim 1, wherein the plurality of documents in the dataset are labeled following a Zipfian distribution.

8. The computer implemented method of claim 1, wherein the subset of labels includes only small classes determined based on how many documents in the plurality of documents in the dataset are tagged a given label.

9. The computer implemented method of claim 1, wherein the first task for training the machine learning model comprises:
representing each of the labels for the first task as a vector,
computing a cosine distance between the labels for the first task and an output from the machine learning model,
determining a weight matrix for the first task based on the computed cosine distances,
classifying a sample of the output from the machine learning model therewith providing a dense output for the first task, and
multiplying the dense output for the first task with the weight matrix for the first task therewith providing a final classification output.

10. The computer implemented method of claim 1, The computer implemented method of claim 1, wherein the second task for training the machine learning model comprises:
representing each of the labels for the second task as a vector,
computing a cosine distance between the labels for the second task and an output from the machine learning model,
determining a weight matrix for the second task based on the computed cosine distances,
classifying a sample of the output from the machine learning model therewith providing a dense output for the second task, wherein labels for the second task include only small classes determined based on how many documents in the plurality of documents in the dataset are tagged a given label, and
multiplying the dense output for the second task with the weight matrix for the second task therewith providing a small classification output.

11. The computer implemented method of claim 1, comprising pretraining the machine learning model using a portion of at least one document in the dataset.

12. The computer implemented method of claim 1, comprising pretraining the machine learning model using at least one document with noisy text filtered therefrom.

13. The computer implemented method of claim 1, comprising pretraining the machine learning model using documents processed with N-Gram topic modeling.

14. The computer implemented method of claim 1, comprising pretraining the machine learning model using sentence reranking.

15. The computer implemented method of claim 1, comprising pretraining the machine learning model using masked language modeling.

16. The computer implemented method of claim 15, wherein masked language modeling comprises randomly selecting tokens from the original document and replacing a portion of the selected tokens with a mask token, and wherein the machine learning model predicts token values based on tokens surrounding the mask token.

17. A computer implemented method for classifying documents comprising:
training, by a computer device, a general-domain corpora pretrained machine learning model with a domain specific dataset comprising a plurality of documents each annotated with at one label selected from a plurality of predefined labels for a given domain following a Zipfian distribution, wherein the machine learning model is trained using a multi-task learning process comprising:
a first task for training the machine learning model with respect to all of the labels used for the plurality of documents in the dataset, and
a second task for training the machine learning model with respect to a subset of all of the labels used for the plurality of documents in the dataset, which subset includes only small classes determined based on class frequency, wherein at least one of the first and the second task for training the machine learning model comprises:
representing each of the labels for the at least one of the first and the second task as a vector,
computing a cosine distance between the labels for the at least one of the first and the second task and an output from the machine learning model,
determining a weight matrix for the at least one of the first and the second task based on the computed cosine distances,
classifying a sample of the output from the machine learning model therewith providing a dense output for the at least one of the first and the second task, and
multiplying the dense output for the at least one of the first and the second task with the weight matrix for the first task therewith providing a classification output; and
predicting, by the computer device, using the trained machine learning model, at least one label from the plurality of labels for at least one other document

18. The computer implemented method of claim 17, comprising pretraining the machine learning model using at least one document processed using at least one of sentence reranking and filtering noisy text therefrom.

19. The computer implemented method of claim 17, comprising pretraining the machine learning model using documents processed with N-Gram topic modeling.

20. The computer implemented method of claim 17, comprising pretraining the machine learning model using masked language modeling.
